(19) United States
(12) Patent Application Publication
(10) Pub. No.: US 2018/0293357 A1
(43) Pub. Date: Oct. 11, 2018

(54) PILL COLLECTION VISUAL RECOGNITION FOR AUTOMATIC COMPLIANCE TO PRESCRIPTIONS

(71) Applicant: International Business Machines Corporation, Armonk, NY (US)

(72) Inventors: Noel Christopher CODELLA, White Plains, NY (US); Jonathan Hudson CONNELL, II, Cortlandt-Manor, NY (US); Sharathchandra Umapathirao PANKANTI, Darien, CT (US); Nalini K. RATHA, White Plains, NY (US)

(21) Appl. No.: 15/483,126

(22) Filed: Apr. 10, 2017

(51) Int. Cl. G06F 19/00; G06Q 30/00; G06Q 50/22

(52) U.S. Cl. CPC G06F 19/3456; G06Q 30/0185; G06K 9/6267; G06F 19/3487; G06Q 50/22; G06F 19/326

(57) ABSTRACT

Visual recognition of medications involves determining an identity of each dispensed medication in a plurality of different medications and a dosage for each dispensed medication from a picture containing the plurality of different medications. The medications include non-pill medications. Each dispensed medication and the dosage for each dispensed medication is compared to a therapeutic treatment regime containing a plurality of designated medications and a dosage schedule for each designated medication. Previous failures to follow the therapeutic treatment regime are identified. The picture containing the plurality of different medications is analyzed for any counterfeit medications in the dispensed medications. A therapeutic treatment regime report summarizing compliance between each dispensed medication and dosage for each dispensed medication and the therapeutic treatment regime, an identification of all counterfeit medications in the dispensed medications and recommendation to remediate the previous failures are generated.

### FIELD OF THE INVENTION

The present invention relates to monitoring of medication dosages and visual recognition systems.

### BACKGROUND OF THE INVENTION

Prescription medications need to be taken according to a particular schedule or sequence. Patients need to follow these schedules and sequences to achieve the desired therapeutic efficiency and to avoid undesired side effects or drug interactions. Factors such as age, experience, expertise, fatigue and busy schedules complicate the ability of patients to following the proper dosage schedules and sequences. Additional complications are introduced when patients are prescribed multiple medications or patients want to combine over the counter medications with their prescription medications.

Children, the elderly and the mentally disabled are often in need of assistance to track their prescription compliance and consumption, especially when multiple medications are prescribed. When a caregiver is tracking medication consumption a patient, that caregiver could also benefit from a double-check regarding the medications, dosages and schedule being followed. This would be particularly helpful for caregivers that are responsible for multiple patients or for parents that are caring for multiple children.

### SUMMARY OF THE INVENTION

Exemplary embodiments are directed to systems and methods for automated identification and tracking of medication consumption from photographs of medication. These photographs are used to identify the type and dosage of one or more medications and to check these medications and dosages against prescriptions. The photographs are also used to identify known fraudulent medications.

Exemplary embodiments are directed to a method for visual recognition of medications. According to the method, an identity of each dispensed medication in a plurality of different medications and a dosage for each dispensed medication are identified from a picture containing the plurality of different medications. Each dispensed medication and the dosage for each dispensed medication are compared to a therapeutic treatment regime containing a plurality of designated medications and a dosage schedule for each designated medication. The picture containing the plurality of different medications is also analyzed for any counterfeit medications in the dispensed medications, and a therapeutic treatment regime report is generated that summarizes compliance between each dispensed medication and dosage for each dispensed medication and the therapeutic treatment regime and that also identifies all counterfeit medications in the dispensed medications.

Exemplary embodiments are also directed to a method for visual recognition of medications where an identity of each dispensed medication in a plurality of different medications and a dosage for each dispensed medication are identified from a picture containing the plurality of different medications comprising at least one of powders, liquids, aerosols and ointments. Each dispensed medication and the dosage for each dispensed medication are compared to a therapeutic treatment regime containing a plurality of designated medications and a dosage schedule for each designated medication. A therapeutic treatment regime report is generated that summarizes compliance between each dispensed medication and dosage for each dispensed medication and the therapeutic treatment regime.

Exemplary embodiments are directed to a method for visual recognition of medications in which an identity of each dispensed medication in a plurality of different medications and a dosage for each dispensed medication are identified from a picture containing the plurality of different medications and each dispensed medication and the dosage for each dispensed medication are compared to a therapeutic treatment regime containing a plurality of designated medications and a dosage schedule for each designated medication. Previous failures to follow the therapeutic treatment regime are identified. The previous failures include at least one of missing dosages of designated medications, improper dosages of designated medications and deviations from the dosage schedule. A therapeutic treatment regime report is generated that summarizes compliance between each dispensed medication and dosage for each dispensed medication and the therapeutic treatment regime and that provides recommended modifications to one or more dispensed medications or dosages for one or more dispensed medications to remediate the previous failures.

### BRIEF DESCRIPTION OF THE DRAWINGS

FIG. 1 is flow chart illustrating an embodiment of a method for visual recognition of medications;

FIG. 2 is schematic representation of an embodiment of a system for visual recognition of medications;

FIG. 3 is a schematic represent of an embodiment of a mixture of a plurality of dispensed medication;

FIG. 4 depicts a cloud computing environment according to an embodiment of the present invention; and

FIG. 5 depicts abstraction model layers according to an embodiment of the present invention.

### DETAILED DESCRIPTION

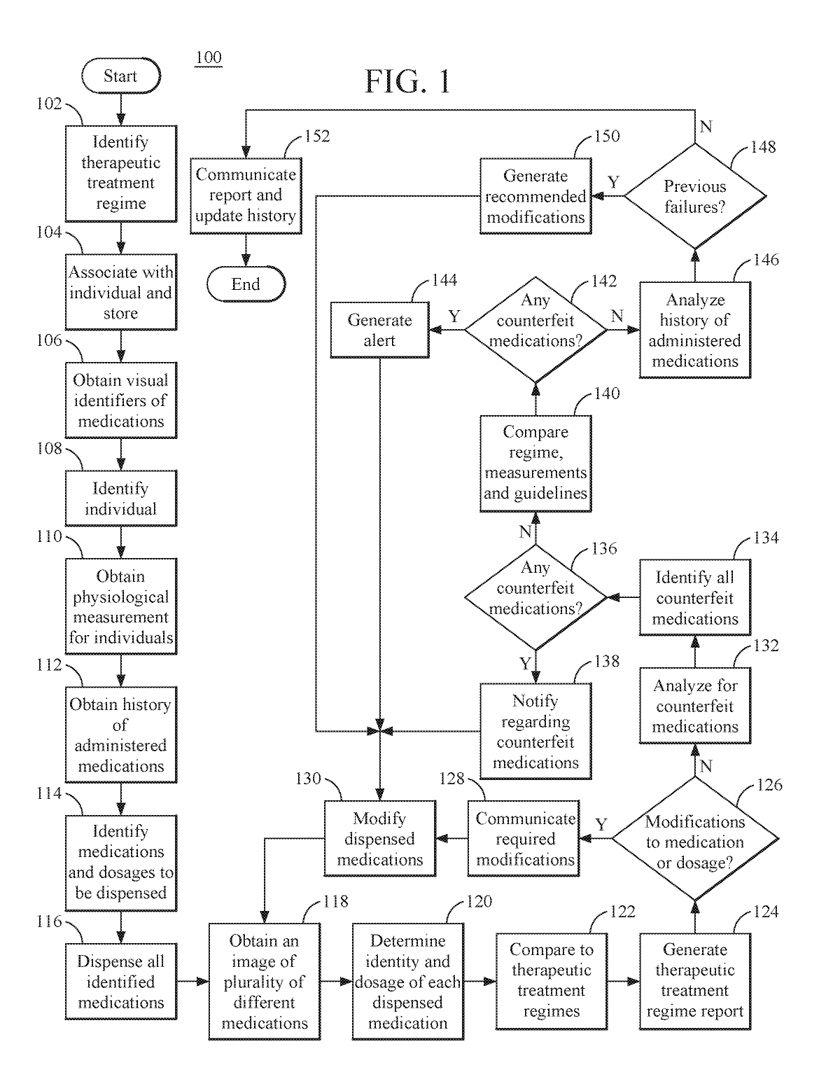

Referring initially to FIG. 1, exemplary embodiments are directed to a method for visual recognition of medications 100. At least one therapeutic treatment regime is identified 102. The therapeutic treatment regime is associated with an individual or patient. In addition to human patients, the therapeutic treatment regime can be for other animals. In one embodiment, a plurality of therapeutic treatment regimes is identified. Each therapeutic treatment regime is associated with a given individual. The therapeutic treatment regime identifies at least one designated medication and a dosage schedule for the designated medication for a given individual. Alternatively, the therapeutic treatment regime identifies a plurality of designated medications and a dosage schedule for each designated medication for the given individual.

Suitable designated medications include both prescription medications and non-prescription or over-the-counter medications. As the therapeutic treatment regime can include prescription medications, the therapeutic treatment regime can include at least one prescription. In one embodiment, the therapeutic treatment regime includes a plurality of prescriptions. For non-prescription medications, the therapeutic treatment regime includes medication guidelines provided with the non-prescription medications, for example, from the manufacturer of those non-prescription medications or from a third party, i.e., regulatory agency. Each medical guideline includes, for example, dosage recommendations, dosage schedules, dosage methods, potential adverse reactions, potential side effects and health warnings. For an individual being administered a single over-the-counter or non-prescription medication, the medical guidelines for that single non-prescription medication represent the therapeutic treatment regime.

Each therapeutic treatment regime can be obtained from input from one or more sources. Prescriptions can be uploaded to a computing system or database by a prescribing physician or dispensing pharmacy. Physicians and pharmacies can also provide an identification and recommended dosage schedule for non-prescription medication. Caregivers, nurses, hospitals, dispensaries and parents can also identify and upload prescription and non-prescription medications and dosage schedules for a given individual. In one embodiment, the individual uploads the prescription and non-prescription medications and dosage schedules. This includes the individually uploading the actual prescriptions obtained from the physician. Relevant medication and dosage information is also obtained from third party sources including medication manufacturers and regulatory agencies. In one embodiment, multiple sources are used to obtain the desired designated medications and dosage schedules. All of the obtained designated medications and dosage schedules for a given therapeutic treatment regime are associated with a given individual 104 and stored in a database. The therapeutic treatment regime stored in a database can be updated over time.

Visual identifiers for all of the designated medications are obtained 106. In general, visual identifiers include descriptions and images of the designated medications that can be used to identify the designated medications from an image, for example, a two-dimensional image of the designated image. Suitable visual identifiers include, but are not limited to, colors, markings, shapes, pictures, drawings and dimensions. In one embodiment, the visual identifiers also include an identification of the dosages associated with the medications or information sufficient to determine dosage based on an image of the designated medication. The visual identifiers, including any dosage determination information, are also stored in the database.

A given individual, for which a therapeutic treatment regime exists in the database, is identified 108. Alternatively, a plurality of individuals is identified, each having an associated and stored therapeutic treatment regime. Individuals can be identified by a physician, hospital, caregiver, parent or the individual. In general, a given individual will be the recipient of at least one or a plurality of different medications. In one embodiment, physiological measurements are obtained for each recipient of a given plurality of different medications 110, i.e., each individual. Suitable physiological measurements include, but are not limited to, weight, height, pulse, blood-pressure, heart rate, age and sex. The physiological measurements can also identify individuals that are nursing, pregnant or injured.

For each identified individual or recipient of at least one or a plurality of medications, a history of administered medications is obtained 112. The history of administered medications includes, but is not limited to, an identity of each medication, the dosage of each medication, the times at each medication were administered, information regarding efficacy of previously administered medications and previous adverse reactions to any administered medication. In addition, for each individual or recipient of at least one or a plurality of medications all medications to be dispensed and given to that individual and dosages for each medication are identified 114. In one embodiment, the medications and dosages are identified from the therapeutic treatment regime for that individual. All of the identified medications are dispensed in the identified dosages 116. Suitable dispensed medications include, but are not limited to, pills, e.g., tablets and capsules, powders, liquids, e.g., oral, injectable, drops and suspensions, aerosols, e.g., sprays and inhalants, and ointments, e.g., creams and lotions.

At least one image or picture of the plurality of medications is obtained 118. In one embodiment, the plurality of medications is a mixture of all dispensed medications. Alternatively, a plurality of images can be generated for each of a plurality of medications. Each given plurality of medications contains at least one and preferably two or more of the dispensed medications. In one embodiment, the plurality of medications includes two or more of pills, powders, liquids, aerosols and ointments. In one embodiment, one or more dispensed medications, and therefore the picture of the plurality of medications, include a fraction of a pill, e.g., a pill that is broken in half. The picture or image of the plurality of medications can be obtained using any suitable device for obtaining a picture or images including cameras and scanners. Suitable cameras include, but are not limited to, cellular phone cameras, webcams, smartphone cameras, tablet computer cameras and dedicated cameras attached to a computing system. Suitable images include two dimensional images and three dimensional images. Preferably, the picture or image of the plurality of medications is a two dimensional image.

An identity of each dispensed medication in a plurality of different medications and a dosage for each dispensed medication are determined 120 from the picture containing the plurality of different medications. In one embodiment, the picture is compared to the visual identifiers obtained for each designated medication. The picture or image of the plurality of medications can also be compared to additional description information obtained for the designated medications. Each dispensed medication and the dosage for each dispensed medication is compared to the therapeutic treatment regime 122. A therapeutic treatment regime report is generated 124 that summarizes compliance between each dispensed medication and dosage for each dispensed medication and the therapeutic treatment regime.

Based on the therapeutic treatment regime report, a determination is made regarding the need to modification in either a dispensed medication or the dosage of a dispensed medication 126. These modifications include removing dispensed medication, adding a dispensed medication, substituting a new dispensed medication for an existing dispensed medication and modifying a dosage of a dispensed medication. The required modifications to the dispensed medications in the plurality of medication is communicated to the individual or the care giver 128, and the dispensed medications are modified accordingly 130.

If modifications are not required, the picture containing the plurality of different medications is analyzed for any counterfeit medications in the dispensed medications 132; and all counterfeit medications in the dispensed medications are identified 134. A determination is then made regarding whether or not the dispensed medications include any counterfeit medication 136. If counterfeit medications do exist, then the individual or other responsible person such as the care giver is notified 138, and the dispensed medications are modified accordingly 130, this time to remove or replace the counterfeit medications.

If the dispensed medications do not include any counterfeit medications, then at least one of the therapeutic treatment regime, physiological measurements of the individual and medication guidelines for each dispensed medication are compared 140 for each dispensed medication. Based on this comparison, a determination is made regarding any potential conflicts among the therapeutic treatment regime, physiological measurements of the individual and medication guidelines for each dispensed medication 142. These conflicts include, but are not limited to, adverse drug interactions, physiological measurements out of compliance with the medication guidelines and physiological measurements indicating a need for modification of the therapeutic treatment regime. If conflicts are identified, an alert is generated 144 that identifies each a conflict among the therapeutic treatment regime, physiological measurements and medication guidelines for each dispensed medication. The generated alert is also communicated to the individual or other responsible person such as the care giver. In one embodiment, the alert includes an identification of each specific conflict and recommended changes to overcome the conflict. The dispensed medication are then modified 130 to overcome or remove these conflicts.

If not conflicts are identified, the history of administered medications for the individual is analyzed 146 to identify previous failures to follow the therapeutic treatment regime. Suitable previous failures include at least one of missing dosages of designated medications, improper dosages of designated medications and deviations from the dosage schedule. A determination is made regarding whether or not previous failures to follow the therapeutic treatment regime exist 148. In one embodiment, the individual or caregiver identify and input previous failures, e.g., missed treatments or improper dosages. If failures exist, recommended modifications to one or more dispensed medication or dosages for one or more dispensed medications are generated in order to remediate the previous failures 150. These recommended modifications are communicated to the individual or other responsible person such as the care giver. In one embodiment, the alert includes an identification of each specific conflict and recommended changes to overcome the conflict. The dispensed medication are then modified 130 in accordance with the recommended modifications to remediate the previous failures to follow the therapeutic treatment regime. In one embodiment, following the modification of the dispensed medications for any reason, modifications, counterfeits and conflicts, an image is then obtained of the plurality of medications containing the dispensed medications as modified. In one embodiment, a new or updated image is not generated. Alternatively, the individual or other responsible person can select to modify the dispensed medications in accordance with the recommendations or to override the communicated modifications.

If no previous failures are identified that require remediation or that can be rectified by remedial actions, then the therapeutic treatment regime report is communicated to the individual and the history of administered medications is updated 152. In one embodiment, the therapeutic treatment regime report can be modified by the individual or caretaker to made updates or correct errors. Therefore, the therapeutic treatment regime report is stored in an editable format. In addition, an auditable record of the edits or modification are stored for future reference.

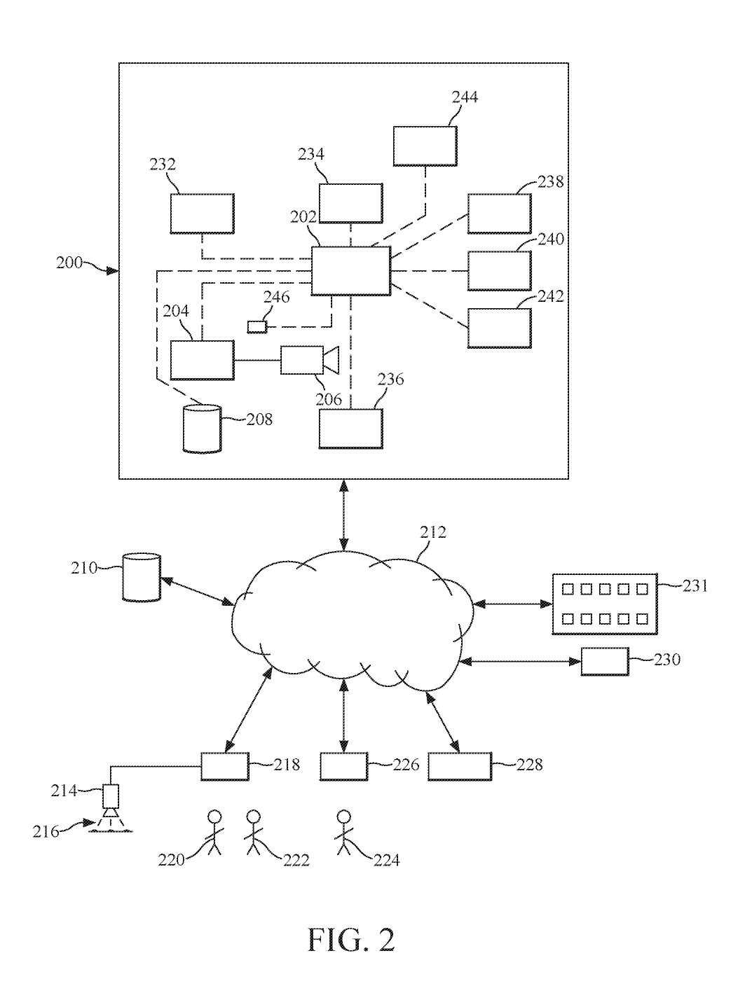

Referring now to FIG. 2, exemplary embodiments are also directed to a system for visual recognition of medications 200. The system includes at least one central processing unit 202 capable of providing all of the necessary processing for visual recognition of medication. The system also includes at least one database 208 in communication with the central processing unit. The system for visual recognition of medications includes a clock, which can be used to monitor compliance with the dosage schedule in any therapeutic treatment regime. The system may also be in communication with one or more additional databases 210 across one or more local or wide area networks 212. The database stores the software code that when executed by the central processing unit causes the system to provide all of the functionality for visual recognition of medication. The data also includes at least one therapeutic treatment regime associated with an individual, patient or other animal. In one embodiment, that database contains a plurality of therapeutic treatment regimes. Each therapeutic treatment regime is associated with a given individual. As discussed above, each therapeutic treatment regime identifies at least one designated medication and a dosage schedule for the designated medication for a given individual.

Each therapeutic treatment regime is obtained from, for example, prescriptions uploaded to the system for visual recognition of medications from a computing system 226 or database associated with a prescribing physician 224 or from a dispensing pharmacy 228. Therapeutic treatment regimes can also be communicated by caregivers 222, i.e., nurses, hospitals, dispensaries and parents, or from the individuals 220 themselves using computing equipment 218 associated with the caregivers or individuals. In one embodiment, the individual 220 uploads the prescription and non-prescription medications and dosage schedules. Relevant medication and dosage information is also obtained from third party sources 230 including medication manufacturers and regulatory agencies. In one embodiment, multiple sources are used to obtain the desired designated medications and dosage schedules. All of the obtained designated medications and dosage schedules for the therapeutic treatment regimes are stored in a database and updated over time.

The database also includes visual identifiers for all of the designated medications. These visual identifiers can be obtained from a manufacturer 231 of a given medication or from third party sources 230. In general, visual identifiers include descriptions and images of the designated medications that can be used to identify the designated medications from an image, for example, a two-dimensional image of the designated image. Suitable visual identifiers include, but are not limited to, colors, markings, shapes, pictures, drawings and dimensions. In one embodiment, the visual identifiers also include an identification of the dosages associated with the medications or information sufficient to determine dosage based on an image of the designated medication. The visual identifiers, including any dosage determination information, are also stored in the database.

In one embodiment, the database includes physiological measurements obtained for each recipient of a given plurality of different medications, i.e., each individual. Suitable physiological measurements include, but are not limited to, weight, height, pulse, blood-pressure, heart rate, age and sex. The physiological measurements can also identify individuals that are nursing, pregnant or injured.

For each identified individual or recipient of at least one or a plurality of medications, a history of administered medications is maintained in the database. The history of administered medications includes, but is not limited to, an identity of each medication, the dosage of each medication, the times at each medication were administered, information regarding efficacy of previously administered medications and previous adverse reactions to any administered medication.

The system for visual recognition of medications includes an image capture module 204 in communication with the central processing unit. In one embodiment, the image capture module is in communication with at least one camera 206. Alternatively, the image capture module is in communication with the remote camera 214 associated with an individual 220 or the caregiver 222 for that individual. The remote camera is in communication with the image capture module through a computing system 218 and across one or more networks 212. Either the camera 206 associated with the system or the remote camera are used to obtained at least one image or picture of the plurality of medications 216 and to communicate each image to the image capture module. Suitable cameras include, but are not limited to, cellular phone cameras, webcams, smartphone cameras, tablet computer cameras and dedicated cameras attached to a computing system. Suitable images include two dimensional images and three dimensional images. Preferably, the picture or image of the plurality of medications is a two dimensional image. The dispensed medications can be placed in a tray or other suitable surface such that all dispensed medications are contained within the field of view of the camera. The image capture module can also be in communication with scanners to obtain a picture or image of the dispensed medications.

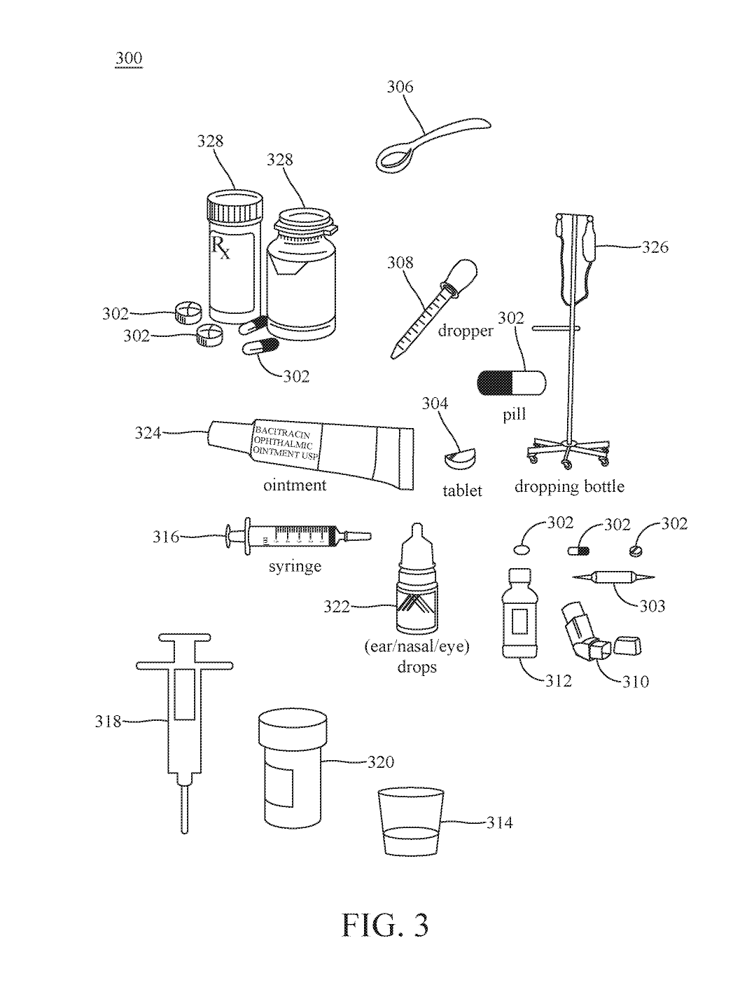

Referring now to FIG. 3, the plurality of medications 300 is a mixture of at least a portion and preferably all dispensed medications. In one embodiment, the plurality of medications includes two or more of pills, powders, liquids, aerosols and ointments. The plurality of medications can include pills 302. These pills include tablets, capsules and gelatin capsules and can include a fraction of a pill, e.g., a pill that is broken in half. The pills can be provided either alone or in combination with the prescription bottles 328 from which the pills were dispensed. The mixture of the plurality of dispensed medications can also include liquids for example, oral liquids 308 in a dropper dispenser, intravenous medications 326 in a dropping bottle, liquids in a vial 303, oral liquids 316 in syringe, injectable liquids in a syringe 318 with the bottle 320 containing the bulk injectable liquids, liquid drops in a dropper bottle 322 for ear, nose or eyes, ingestible liquids in a graduated dispensing cup 314, for example with the bottle 312 containing the bulk ingestible liquid and ingestible liquids 306 in a spoon. The mixture of the plurality of dispensed medications for image capture can also include suspensions, aerosols including sprays and inhalants 322, and ointments 324, e.g., creams and lotions.

Returning to FIG. 2, the system for visual recognition of medications also includes an image analysis and medication identifying module 232 in communication with the central processing unit. The image analysis module identities of each dispensed medication in the plurality of different medications and the dosage for each dispensed medication from the picture containing the plurality of different medications. The analysis module can analyze shapes, sizes, colors, graphics and alpha-numeric characters. In one embodiment, the analysis module is compares the visual identifiers obtained for each designated medication to the picture. The analysis module can also compare the picture or image of the plurality of medications to additional description information obtained for the designated medications. The system for visual recognition of medications contains a treatment regime confirmation module 234 to compare each dispensed medication and the dosage for each dispensed medication to the therapeutic treatment regime. The treatment regime confirmation module 234, based on the comparison between the treatment regime and the dispensed medications, generates a therapeutic treatment regime report that summarizes compliance between each dispensed medication and dosage for each dispensed medication and the therapeutic treatment regime. The system for visual recognition of medications includes a communication module 236 to provide communication, including the communication of reports, recommendations and alerts, to, for example, individuals, care givers, doctors, pharmacists and hospitals.

The treatment regime confirmation module 234 also determines any needed modifications in either a dispensed medication or the dosage of a dispensed medication. These modifications include removing dispensed medication, adding a dispensed medication, substituting a new dispensed medication for an existing dispensed medication and modifying a dosage of a dispensed medication. The required modifications to the dispensed medications in the plurality of medication is communicated using the communication module.

The system for visual recognition of medications includes a counterfeit medication determination module 238 in communication with the central processor. The counterfeit medication determination module 238 receives the image from the image capture module and the analysis from the image analysis and medication identifying module 232 and analyzes the picture containing the plurality of different medications is analyzed for any counterfeit medications in the dispensed medications. The counterfeit medication determination module 238 identifies all counterfeit medications in the dispensed medications and uses the communication module to notify the individual or other responsible person such as the care giver regarding the existence of counterfeit medication and to provide identifying information regarding the counterfeit medication. This identifying information is sufficient to facilitate removal or replacement of the counterfeit medications.

The system for visual recognition of medications includes a medicine conflict termination module 240 in communication with the central processing unit. The medicine conflict termination module 240 compares at least one of the therapeutic treatment regime, physiological measurements of the individual and medication guidelines for each dispensed medication determines any potential conflicts among the therapeutic treatment regime, physiological measurements of the individual and medication guidelines for each dispensed medication. These conflicts include, but are not limited to, adverse drug interactions, physiological measurements out of compliance with the medication guidelines and physiological measurements indicating a need for modification of the therapeutic treatment regime. The medicine conflict termination module 240, when conflicts are identified, generates an alert that identifies each conflict among the therapeutic treatment regime, physiological measurements and medication guidelines for each dispensed medication. The generated alert is communicated to the individual or other responsible person such as the care giver through the communication module.

The system for visual recognition of medications includes a remediation module 242 in communication with the central processing unit. The remediation module 242 analyzes the history of administered medications for the individual from the database and identifies previous failures to follow the therapeutic treatment regime. Suitable previous failures include at least one of missing dosages of designated medications, improper dosages of designated medications and deviations from the dosage schedule. The remediation module 242 determines when previous failures to follow the therapeutic treatment regime exist and recommends modifications to one or more dispensed medications or dosages for one or more dispensed medications are generated in order to remediate the previous failures. The system for visual recognition of medications can also include functionality that allows the individual or caregivers associated with the individual to select to modify the dispensed medications in accordance with the recommendations or to override the communicated modifications.

The system for visual recognition of medications includes a history update module 244 in communication with the central processing unit and the database to updated the history of administered medications stored in the database. These updates include all dispensed medications and all modifications or changes to the dispensed medications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although a detailed description on cloud computing is provided, implementation of the teachings provided herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

This cloud model may include at least five characteristics, at least three service models, and at least four deployment models. The five characteristics are on-demand self-service, broad network access, resource pooling, rapid elasticity and measured service. Regarding on-demand self-service, a cloud consumer can unilaterally provision computing capabilities, such as server time and network storage, as needed automatically without requiring human interaction with the service's provider. Broad network access refers to capabilities that are available over a network and accessed through standard mechanisms that promote use by heterogeneous thin or thick client platforms, e.g., mobile phones, laptops, and PDAs. For resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter. Rapid elasticity refers to capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. For measured service, cloud systems automatically control and optimize resource use by leveraging a metering capability at some level of abstraction appropriate to the type of service, e.g., storage, processing, bandwidth, and active user accounts. Resource usage can be monitored, controlled, and reported, providing transparency for both the provider and consumer of the utilized service.

The three service models are Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, with the possible exception of limited user-specific application configuration settings. Platform as a service provides the capability to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service provides the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

The Deployment Models are private cloud, community cloud, public cloud and hybrid cloud. The private cloud infrastructure is operated solely for an organization. It may be managed by the organization or a third party and may exist on-premises or off-premises. The community cloud infrastructure is shared by several organizations and supports a specific community that has shared concerns, e.g., mission, security requirements, policy, and compliance considerations. It may be managed by the organizations or a third party and may exist on-premises or off-premises. The public cloud infrastructure is made available to the general public or a large industry group and is owned by an organization selling cloud services. The hybrid cloud infrastructure is a composition of two or more clouds (private, community, or public) that remain unique entities but are bound together by standardized or proprietary technology that enables data and application portability, e.g., cloud bursting for load-balancing between clouds.

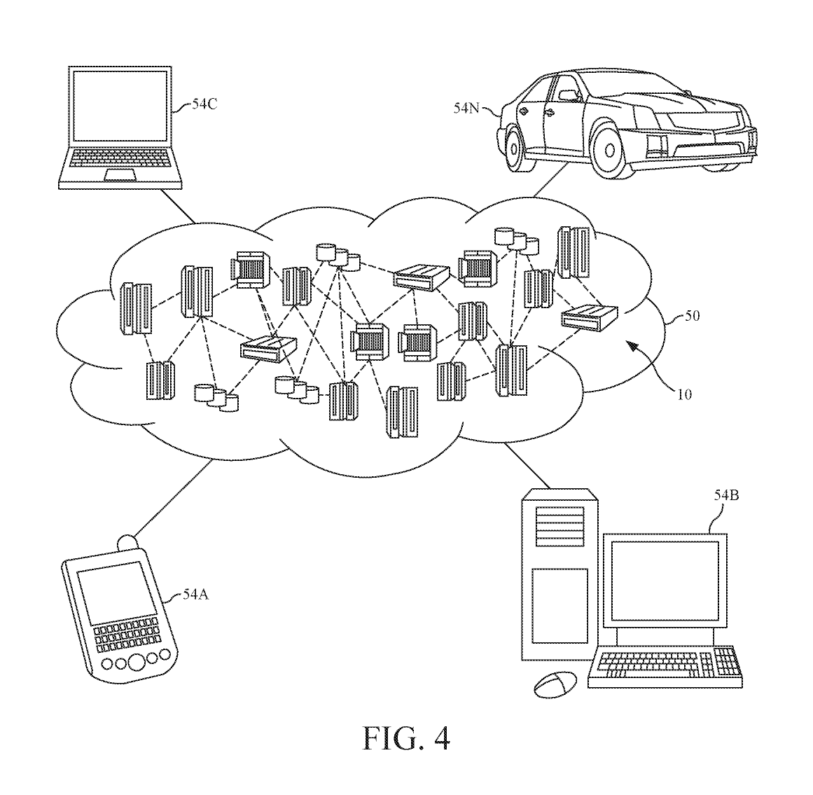

A cloud computing environment is service oriented with a focus on statelessness, low coupling, modularity, and semantic interoperability. At the heart of cloud computing is an infrastructure that includes a network of interconnected nodes. Referring now to FIG. 4, an illustrative cloud computing environment 50 is depicted. As shown, the cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection, e.g., using a web browser.

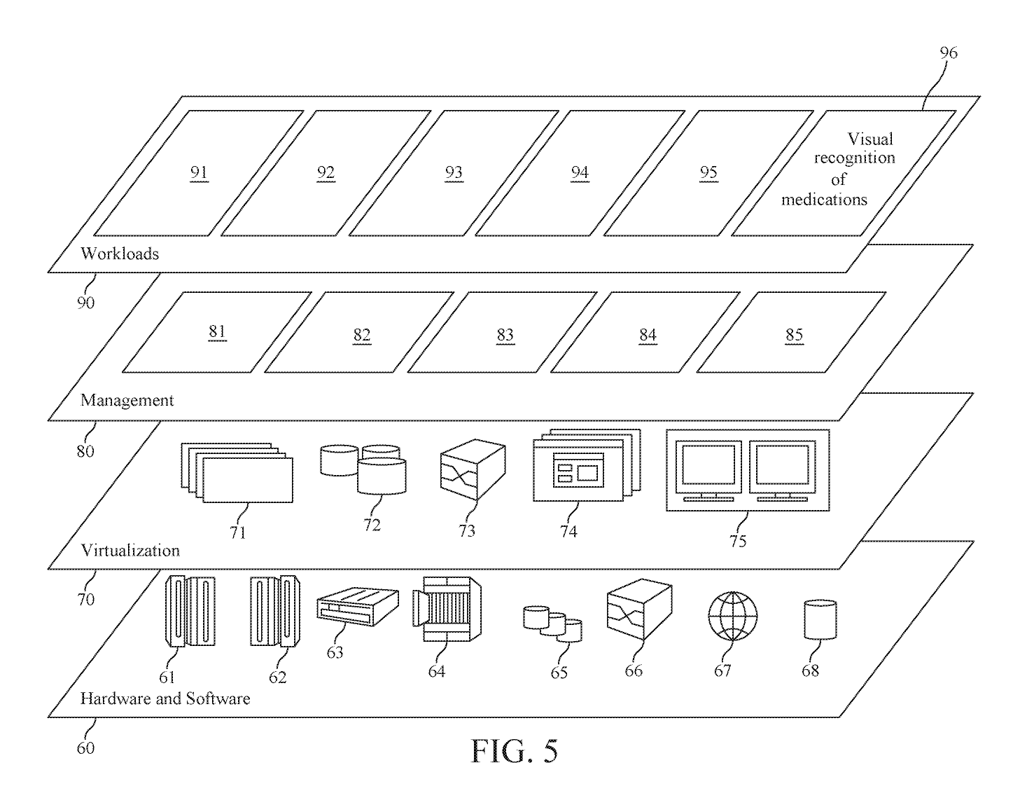

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided. A hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. A virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and visual recognition of medications 96.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for visual recognition of medications in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for visual recognition of medications, the method comprising:
determining an identity of each dispensed medication in a plurality of different medications and a dosage for each dispensed medication from a picture containing the plurality of different medications;
comparing each dispensed medication and the dosage for each dispensed medication to a therapeutic treatment regime comprising a plurality of designated medications and a dosage schedule for each designated medication;
analyzing the picture containing the plurality of different medications for any counterfeit medications in the dispensed medications; and
generating a therapeutic treatment regime report summarizing compliance between each dispensed medication and dosage for each dispensed medication and the therapeutic treatment regime and identifying all counterfeit medications in the dispensed medications.

2. The method of claim 1, wherein:
the picture containing the plurality of different medications comprises a two dimensional picture; and
the method further comprises using a camera to acquire the picture containing the plurality of different medications.

3. The method of claim 2, wherein the camera comprises a smartphone camera.

4. The method of claim 1, wherein the plurality of different medications comprises at least two of pills, powders, liquids, aerosols and ointments.

5. The method of claim 1, wherein the plurality of different medications comprises prescription medications and non-prescription medications.

6. The method of claim 1, wherein at least one dispensed medication in the plurality of different medications comprises a fraction of a pill.

7. The method of claim 1, wherein the method further comprises obtaining at least one therapeutic treatment regime comprising at least one prescription.

8. The method of claim 1, wherein the method further comprises:
obtaining physiological measurements for a recipient of the plurality of different medications;
comparing the therapeutic treatment regime, physiological measurements and medication guidelines for each dispensed medication; and
generating an alert identifying a conflict among the therapeutic treatment regime, physiological measurements and medication guidelines for each dispensed medication.

9. The method of claim 1, wherein the method further comprises:
identifying previous failures to follow the therapeutic treatment regime, the previous failures comprising at least one of missing dosages of designated medications, improper dosages of designated medications and deviations from the dosage schedule; and
generating recommendation modifications to one or more dispensed medications or dosages for one or more dispensed medications to remediate the previous failures.

10. A method for visual recognition of medications, the method comprising:
determining an identity of each dispensed medication in a plurality of different medications and a dosage for each dispensed medication from a picture containing the plurality of different medications comprising at least one of powders, liquids, aerosols and ointments;
comparing each dispensed medication and the dosage for each dispensed medication to a therapeutic treatment regime comprising a plurality of designated medications and a dosage schedule for each designated medication; and
generating a therapeutic treatment regime report summarizing compliance between each dispensed medication and dosage for each dispensed medication and the therapeutic treatment regime.

11. The method of claim 10, wherein:
the picture containing the plurality of different medications comprises a two dimensional picture; and
the method further comprises using a smartphone camera to acquire the picture containing the plurality of different medications.

12. The method of claim 10, wherein at least one dispensed medication in the plurality of different medications comprises a fraction of a pill.

13. The method of claim 10, wherein:
the plurality of different medications comprises prescription medications and non-prescription medications; and
the method further comprises obtaining at least one therapeutic treatment regime comprising at least one prescription.

14. The method of claim 10, wherein the method further comprises:
obtaining physiological measurements for a recipient of the plurality of different medications;
comparing the therapeutic treatment regime, physiological measurements and medication guidelines for each dispensed medication; and
generating an alert identifying a conflict among the therapeutic treatment regime, physiological measurements and medication guidelines for each dispensed medication.

15. The method of claim 10, wherein the method further comprises:
identifying previous failures to follow the therapeutic treatment regime, the previous failures comprising at least one of missing dosages of designated medications, improper dosages of designated medications and deviations from the dosage schedule; and
generating recommendation modifications to one or more dispensed medication or dosages for one or more dispensed medications to remediate the previous failures.

16. A method for visual recognition of medications, the method comprising:
determining an identity of each dispensed medication in a plurality of different medications and a dosage for each dispensed medication from a picture containing the plurality of different medications;
comparing each dispensed medication and the dosage for each dispensed medication to a therapeutic treatment regime comprising a plurality of designated medications and a dosage schedule for each designated medication;
identifying previous failures to follow the therapeutic treatment regime, the previous failures comprising at least one of missing dosages of designated medications, improper dosages of designated medications and deviations from the dosage schedule; and
generating a therapeutic treatment regime report summarizing compliance between each dispensed medication and dosage for each dispensed medication and the therapeutic treatment regime and providing recommended modifications to one or more dispensed medications or dosages for one or more dispensed medications to remediate the previous failures.

17. The method of claim 16, wherein:
the picture containing the plurality of different medications comprises a two dimensional picture; and
the method further comprises using a smartphone camera to acquire the picture containing the plurality of different medications.

18. The method of claim 16, wherein the plurality of different medications comprises at least two of pills, powders, liquids, aerosols and ointments.

19. The method of claim 16, wherein at least one dispensed medication in the plurality of different medications comprises a fraction of a pill.

20. The method of claim 16, wherein the method further comprises:
obtaining physiological measurements for a recipient of the plurality of different medications;
comparing the therapeutic treatment regime, physiological measurements and medication guidelines for each dispensed medication; and
generating an alert identifying a conflict among the therapeutic treatment regime, physiological measurements and medication guidelines for each dispensed medication.
